(19) United States
(12) Patent Application Publication
(10) Pub. No.: US 2005/0005875 A1
(43) Pub. Date: Jan. 13, 2005

(54) Portable dog-washing unit

(76) Inventor: William Suggs, Alexandria, VA (US)

Correspondence Address: Law Office of Timothy M. Barlow, P.O. Box 64775, Tucson, AZ, 85728-4775, US

(21) Appl. No.: 10/864,996

(22) Filed: Jun. 10, 2004

Related U.S. Application Data
(60) Provisional application No. 60/482,236, filed on Jun. 25, 2003.

(51) Int. Cl. A01K 15/04

(52) U.S. Cl. 119/728

(57) ABSTRACT

A portable dog-washing unit comprises a base stand, the base stand, a socket receptacle, a support rod and a sling. The base stand comprises a U-shaped bar oriented horizontally for maximum stability on a horizontal ground surface. The socket receptacle is fixed to the base stand at the base of the U-shape in the base stand. The support rod is removably attached to the receptacle and is oriented vertically. The support rod further comprises a suspension arm and a hook attached to the top of the support rod and oriented approximately horizontally. The hook is located at the end of the suspension arm and elevated above and between the two arms of the U-shape of the base stand. The sling is removably attached to the hook and generally defines the shape of the torso of the animal to be held within the sling, whereby the animal is restrained within the sling and prevented from touching the ground.

### PRIORITY

This application claims benefit of U.S. Provisional Patent Application Ser. No. 60/482,236, filed on Jun. 25, 2003.

### BACKGROUND OF THE INVENTION

1. Field of the Invention

The present invention relates generally to animal washing devices, and more specifically to a portable, freestanding dog washing unit.

2. Description of Related Art

Many people keep animals, such as dogs, as pets or personal companions. Despite this close relationship with humans, animals continue to behave like animals on a regular basis. The result is that the animals frequently require bathing to eliminate odors or to make them more presentable. Dogs are among the most common recipients of baths, but it has never been easy.

Dogs tend to resist all efforts to bathe them. As a result, humans have developed numerous devices to aid them in bathing their dogs. Among these devices are restraints, enclosures, cradles, and lifts. The single commonality among the multitude of prior art devices is that they prevent an animal from escaping. However, many of these devices are large, complex, or hazardous to operate. A person cannot easily disassemble these devices and store them in a drawer or closet. Further, some of these devices may harm a restrained animal, particularly if the animal struggles.

U.S. Pat. No. 1,879,915, issued to Smoot on Jun. 10, 1929, discloses a Portable Animal Bath. However, the device simply restrains the animal without lifting it in a sling.

U.S. Pat. No. 3,580,222, issued to Dunn on May 25, 1971, discloses an Apparatus for Holding Pets. However, the device is not freestanding and does not use a sling to support the animal.

U.S. Pat. No. 4,831,967, issued to Anderson on May 23, 1989, discloses an Animal Lift Frame. However, the sling is not adjustable and not suitable for use in bathing an animal. Further, the support mechanism is very complex.

U.S. Pat. No. 5,531,187, issued to Ward on Jul. 2, 1996, discloses a Multi-Purpose Pet Harness. However, it requires a plurality of adjustable strap sets, each with a buckle. No lift of support mechanism is included.

Thus what is needed is a dog- or animal-washing unit that is portable and freestanding, that does not harm a restrained animal, and that effectively permits a single person to lift and wash an animal without creating an unreasonable risk of injury to the animal.

### SUMMARY OF THE INVENTION

The invention is a portable dog-washing unit. The device permits a person to wash a dog more easily than in a tub or other existing device. The animal is securely restrained against escaping from the device, and the device will not harm the restrained animal. The portable dog-washing unit includes a broad and stable base that accepts a vertical support rod. The support rod includes a suspension arm with an integral hook. The hook supports a sling to carry the animal. A dog or other animal is suspended in the sling, with the dog's feet off the ground. The device is easily operable by one person and is collapsible for storage and portability.

Accordingly, it is a principal object of the invention to provide a dog-washing device that safely restrains the animal to be washed.

It is another object of the invention to teach a dog-washing device that suspends the animal above the ground.

It is a further object of the invention to provide a dog-washing device that is operable by one person.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a portable dog washing unit according to the present invention.

FIG. 2 is a perspective view of a portable dog-washing unit according to the present invention.

FIGS. 3A and 3B are top views of a harness for a portable dog washing unit according to the present invention.

FIG. 4 is a flowchart of the steps for using the portable dog washing unit according to the present invention.

### DETAILED DESCRIPTION OF THE PREFERRED EMBODIMENTS

The portable dog-washing unit includes a broad and stable base that accepts a vertical support rod. The support rod includes a suspension arm with an integral hook. The hook supports a sling to carry the animal. A dog or other animal is suspended in the sling, with the dog's feet off the ground.

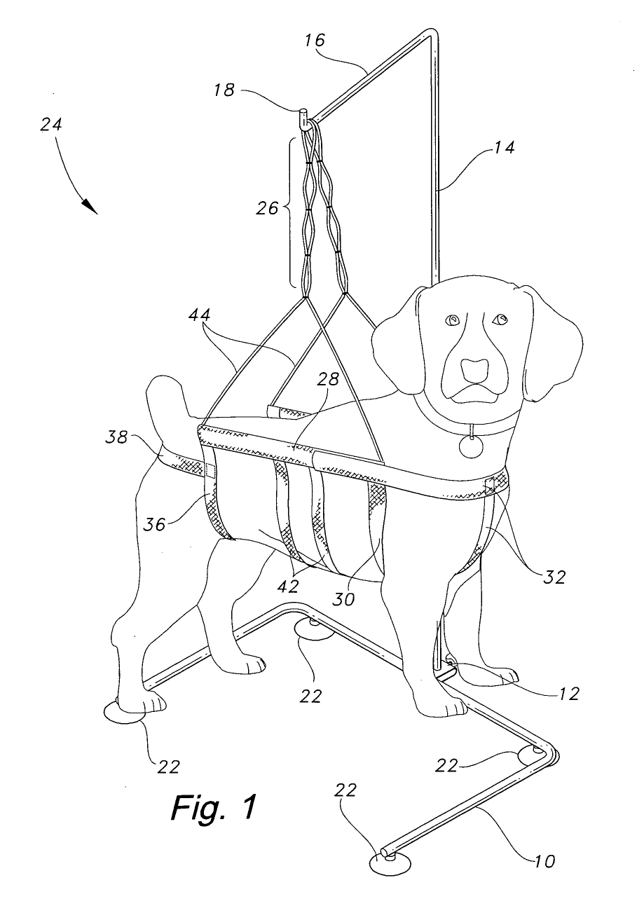

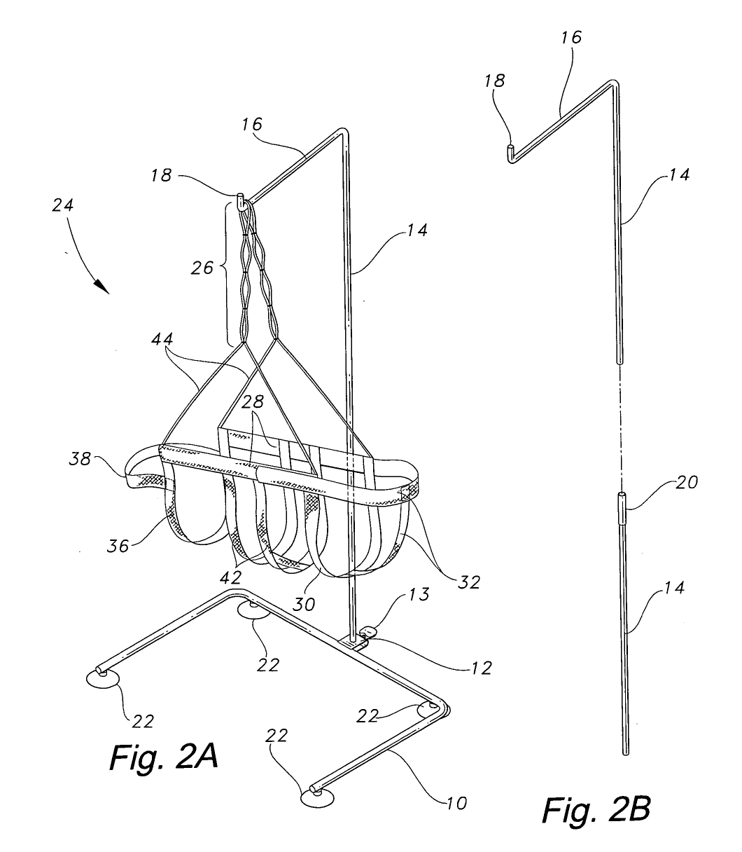

FIGS. 1, 2A and 2B are perspective views of the portable dog-washing unit, both with and without a dog. The base stand 10 is bent into a “U” shape and is oriented horizontally to provide stability. The base stand 10 has a socket receptacle 12 at the bottom of the U to accept and hold a detachable vertical support rod 14. In the preferred embodiment, the receptacle 12 is a blind hole just large enough to accept the support rod 14 and prevents the support rod 14 from going completely through the socket receptacle 12. In one embodiment, the socket receptacle 12 has a thumbscrew 13 for securing the vertical support rod 14 in place. In another embodiment, the socket receptacle 12 has a lip or flange around one edge of the orifice. The lip or flange eases the insertion of the support rod 14 by preventing the lower end of the support rod 14 from slipping out of position when the sling 24 is loaded. The base stand 10 may also include a plurality of suction cups 22, for security and stability when used in a sink, bathtub or other smooth, slick surface.

The vertical support rod 14 rises to a bend, creating a suspension arm 16. A hook 18 is located at the distal end of the suspension arm 16. In one embodiment, the suspension arm 16 declines slightly toward the hook 18. The slight declination acts to keep the sling 24 at the hook 18. In another embodiment, the suspension arm 16 extends generally parallel to the legs in the base stand 10. In this embodiment, the hook 18 includes a small recess to hold the sling 24 in the hook 18. The hook 18 suspends the sling 24 above the base stand 10. When an animal is within the sling 24, the animal is gently restrained for washing. The animal is suspended a few inches above the ground so that the animal cannot escape. The proximity of the ground and the security of the sling 24 act to discourage the animal from shaking or injuring itself trying to escape while being washed. The vertical support rod 14 is flexible, like a spring. The spring-action of the support rod 14 enables the user to connect the animal-laden sling 24 onto the hook 18 and then insert the vertical support rod 14 into the base stand 10, even with a large animal in the sling. The user simply places the lower end of the support rod 14 into the opening of the socket receptacle 12 and pulls back on the support rod 14. The support rod 14 and suspension arm 16 both flex as the support rod 14 is pulled back. As the lower end of the support rod 14 approaches vertical, it falls into the socket receptacle 12. Due to the spring-action of the support rod 14, the animal is lifted off of the ground secure within the sling 24. The portable dog-washing unit is easily manipulated by one person.

In the preferred embodiment, the base stand 10, the vertical support rod 14 and suspension arm 16 are made from metal or synthetic bars both strong enough to support the weight of the animal in the sling and flexible enough to simplify the lifting process. The entire dog-washing unit may be scaled up or down to accommodate different sized animals.

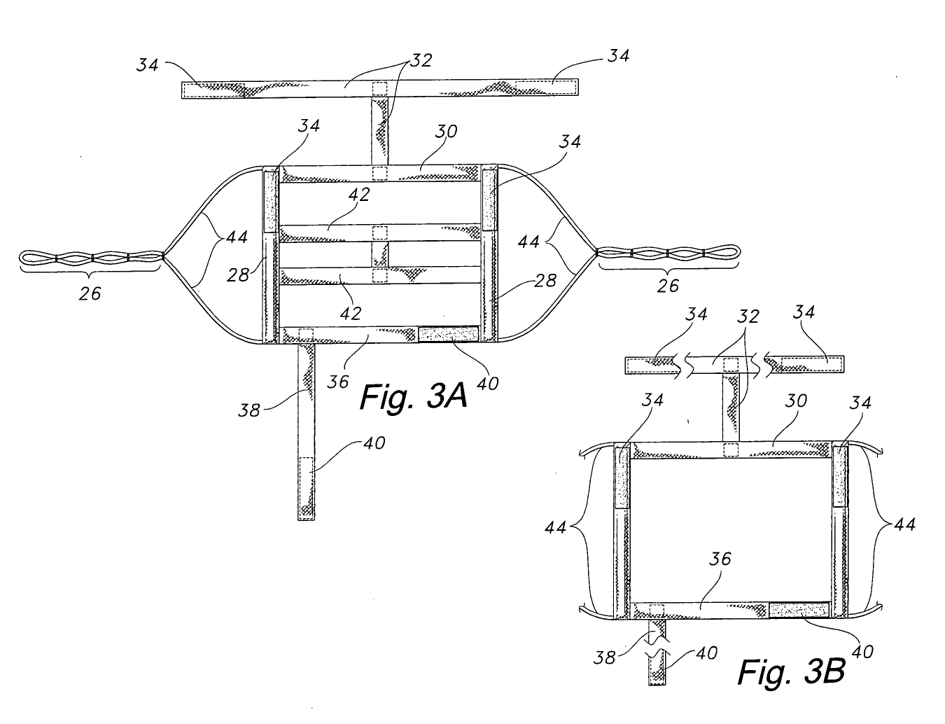

The sling 24 is made of a waterproof or water-resistant material with a few patches of hook and loop material to provide some adjustment capability to accommodate different sizes of dogs, FIGS. 3A and 3B. The sling 24 includes a pair of side bands 28. In the preferred embodiment, the side bands 28 include a stiffener to prevent the sling 24 from collapsing or bunching. A chest strap 30 supports beneath the animal's chest and includes a T-shaped adjustable chest band 32. The two free ends of the chest band 32 include one type of hook and loop material 34 which is removably attached to complementary hook and loop material 34 on the side bands 28. A hind strap 36 supports beneath the animal's pelvis, just head of the rear legs. A hind band 38 is fixed near the left end of the hind strap 36 and includes one type of hook and loop material 40 which is removably attached to complementary hook and loop material 40 near the right end of the hind strap 36. The hind band 38 is adjusted to securely hold the animal behind its legs and beneath its tail. In the preferred embodiment, the sling 24 also includes a belly strap assembly 42, see FIG. 3A. The belly strap 42 provides more comfortably and less stressful support of the animal's abdomen during bathing.

A pair of lift cords 44 is attached to each of the side bands 28. A plurality of elevation loops 26 are attached where each pair of lift cords 44 meet. The lift cords 44 and elevation loops 26 are symmetrically arranged to provide balanced support of the animal. The user should use matching elevation loops 26 on each side of the sling 24 for proper balance. The user should select the elevation loops 26 that prevent the animal from touching the ground with its feet.

The portable dog-washing unit may be made in several sizes to meet special needs. Smaller units can be used in kitchen sink with smaller animals, while larger units may fit a bathtub, a washtub or may be used outside on the ground to meet the user's preference.

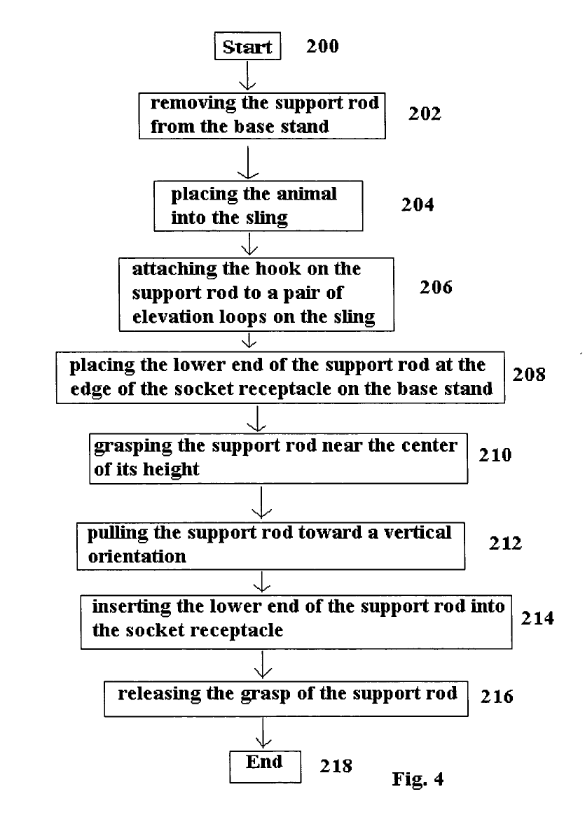

FIG. 4 shows the steps for using the portable dog washing unit. The process starts at step 200 by removing the support rod from the base stand, step 202. At step 204, the animal is placed into the sling, and the hook on the support rod is attached to a pair of elevation loops on the sling, step 206. Next, step 208, the lower end of the support rod is placed at the edge of the socket receptacle on the base stand, and the support rod is grasped near the center of its height, step 210. The support rod is then pulled toward a vertical orientation to align it with the socket receptacle, step 212, and the lower end of the support rod is inserted into the socket receptacle, step 214. Finally, step 216; the user releases the grasp of the support rod, ending the process, step 218. When this process is completed, the user may perform any necessary tasks with the animal. In one embodiment, the user may groom the animal. Grooming includes several tasks, including bathing, cutting hair, trimming nails, inspecting for injuries and many other tasks.

Once the user is finished, the animal may be removed from the device. In one embodiment, removal involves lifting the support rod up and out of the socket receptacle; lowering the animal to the ground; unhooking the sling from the hook; and removing the animal from the sling. While lifting the support rod up and out of the socket receptacle, the user may find it helpful to lift the sling or animal simultaneously to eliminate or reduce any binding of the support rod within the socket receptacle.

Similar reference characters denote corresponding features consistently throughout the attached drawings.

It is to be understood that the present invention is not limited to the sole embodiments described above, but encompasses any and all embodiments within the scope of the following claims.

| Part # | Part Name |
|---|---|
| 10 | base stand |
| 12 | socket receptacle |
| 13 | thumbscrew |
| 14 | support rod |
| 16 | suspension arm |
| 18 | hook |
| 20 | joint |
| 22 | suction cups |
| 24 | sling |
| 26 | elevation loops |
| 28 | side bands |
| 30 | chest strap |
| 32 | chest band |
| 34 | hook and loop material for chest band |
| 36 | hind strap |
| 38 | hind band |
| 40 | hook and loop material for hind band |
| 42 | belly strap |
| 44 | lift cords |

1. A portable dog-washing unit comprising:
a base stand, the base stand comprising a U-shaped bar oriented horizontally for maximum stability on a horizontal ground surface;
a receptacle fixed to the base stand at the base of the U-shape in the base stand;
a support rod removably attached to the receptacle, the support rod oriented vertically and further comprising a suspension arm and a hook, the suspension arm attached to the top of the support rod and oriented approximately horizontally, the hook located at the end of the suspension arm and elevated above and between the two arms of the U-shape of the base stand; and
a sling removably attached to the hook, the sling generally defining the shape of the torso of an animal to be held within the sling, whereby the animal is restrained within the sling and prevented from touching the ground.

2. The portable dog-washing unit of claim 1, wherein the base stand further comprises a plurality of suction cups attached to the base stand, the suction cups evenly spaced and oriented with their concave sides facing downward toward the ground.

3. The portable dog-washing unit of claim 1, wherein the support rod comprises a first rod and a second rod and a sleeve, the first rod being generally straight and the second rod comprising the hook at the distal end and a straight section at the proximal end, the first and second rods being approximately the same length, the sleeve being fixed to one end of the first rod to create an orifice parallel to and concentric with the first rod, the orifice being just large enough to accept the proximal end of the second rod to form a collapsible support rod.

4. The portable dog-washing unit of claim 1, wherein the sling comprises a plurality of paired elevation loops, the elevation loops being symmetrically arranged to provide balanced, level support of the sling.

5. The portable dog-washing unit of claim 1, wherein the sling further comprises belly straps attached to the sling and arranged to provide support to the abdomen of the animal.

6. The portable dog-washing unit of claim 1, wherein the entire portable dog-washing unit is scaled up or down to properly support a large or small dog.

7. A portable dog-washing unit comprising:
a base stand, the base stand comprising a U-shaped bar oriented horizontally for maximum stability on a horizontal ground surface, the base stand further comprising a plurality of suction cups attached to the base stand, the suction cups evenly spaced and oriented with their concave sides facing downward;
a receptacle fixed to the base stand at the base of the U-shape in the base stand;
a support rod removably attached to the receptacle, the support rod oriented vertically and further comprising a suspension arm and a hook, the suspension arm attached to the top of the support rod and oriented approximately horizontally, the hook located at the distal end of the suspension arm and elevated above and between the two arms of the U-shape of the base stand; and
a sling removably attached to the hook, the sling generally defining the shape of the torso of an animal to be held within the sling, whereby the animal is restrained within the sling and prevented from touching the ground, the sling comprising a pair of side bands, each with a front and rear ends and further comprising hook and loop material attached to the front end, a chest strap attached at each end to the front end of the side bands, an adjustable chest band attached near the center of the chest strap, the chest band comprising two free ends with hook and loop material for adjusting and removably attaching to the side bands, a hind strap attached at each end to the rear end of the side band, an adjustable hind band fixed near the left side of the hind strap and removably attached to the right side of the hind strap, and hook and loop material for removably attaching and adjusting the chest band and hind band, a pair of lift cords with two free ends, one lift cord per side band, each free end of the lift cords attached to separate ends of the side bands, and a plurality of symmetrically-arranged paired elevation loops attached to the lift cords at the center of the lift cords.

8. The portable dog-washing unit of claim 7, wherein the sling further comprises a belly strap assembly attached across the center of the sling to the side bands.

9. The portable dog-washing unit of claim 7, wherein the support rod comprises a first rod and a second rod and a sleeve, the first rod being generally straight and the second rod comprising the hook at the distal end and a straight section at the proximal end, the first and second rods being approximately the same length, the sleeve being fixed to one end of the first rod to create an orifice parallel to and concentric with the first rod, the orifice being just large enough to accept the proximal end of the second rod to form a collapsible support rod.

10. A method of using a portable dog washing unit comprising the steps of:
(a) removing the support rod from the base stand;
(b) placing the animal into the sling;
(c) attaching the hook on the support rod to a pair of elevation loops on the sling;
(d) placing the lower end of the support rod at the edge of the socket receptacle on the base stand;
(e) grasping the support rod near the center of its height;
(f) pulling the support rod toward a vertical orientation;
(g) inserting the lower end of the support rod into the socket receptacle; and
(h) releasing the grasp of the support rod.

11. The method of using a portable dog washing unit of claim 10, further comprising:
(i) grooming the animal.

12. The method of using a portable dog washing unit of claim 11, further comprising:
(j) lifting the support rod up and out of the socket receptacle;
(k) lowering the animal to the ground;
(l) unhooking the sling from the hook; and
(m) removing the animal from the sling.
